(19) United States
(12) Patent Application Publication
(10) Pub. No.: US 2015/0326372 A1
(43) Pub. Date: Nov. 12, 2015

(54) Reducing Interference for Shared Spectrum

(71) Applicant: Nokia Corporation, Espoo (FI)

(72) Inventor: Chittabrata Ghosh, Fremont, CA (US)

(73) Assignee: Nokia Corporation, Espoo (FI)

(21) Appl. No.: 14/274,049

(22) Filed: May 9, 2014

(51) Int. Cl. H04L 5/00; H04W 72/08; H04W 72/04

(52) U.S. Cl. CPC H04L 5/0062; H04W 72/0453; H04W 72/082; H04W 72/0446; H04W 72/0413

(57) ABSTRACT

Methods and systems are described herein to reduce interference of communication systems and other wireless technologies, such as a radar system, in a radio frequency band. Embodiments include a shared spectrum access database and shared access controllers. A shared spectrum access database may communicate with a radar system, may communicate with the shared access controllers, and may determine whether there have been changes in the radar's usage of the radio frequency band. The shared spectrum access database may communicate the changes to the shared access controllers. The shared access controllers may cause a communication system to cease operations or allow operations with secondary devices. In some embodiments, the shared spectrum access database may indicate how often the shared access controller sends channel usage requests to the shared spectrum access database.

### BACKGROUND

The proliferation of wireless technology has placed an even increasing demand on the electromagnetic spectrum. In an attempt to lessen the risk of devices interfering with each other when using the electromagnetic spectrum, regulatory bodies or other organizations often impose conditions on how a device accesses and uses the electromagnetic spectrum. In the United States, the Federal Communications Commission (FCC) is one such regulatory body. As one measure of reducing interference between devices competing to use the electromagnetic spectrum, the FCC has allocated the electromagnetic spectrum into a number of radio frequency bands. The FCC further imposes a number of regulations and constraints on the radio frequency bands such as by further dividing a radio frequency band into a number of non-overlapping channels, imposing regulations on the types of users that can access a radio frequency band, and imposing regulations on how devices are to communicate with each other.

For example, the FCC permits some of the radio frequency bands to be accessed by devices of commercial and non-commercial users, while other bands can be accessed only by a user licensed by the FCC. As another example, the FCC has imposed regulations requiring any device that operates within a range of 54 to 698 Megahertz (MHz) (also referred to as TV Band Devices) must communicate with an FCC-mandated database to determine once every 24 hours which channels are available for use.

Other organizations, such as the Institute of Electrical and Electronics Engineers (IEEE) and the European Telecommunications Standards Institute (ETSI), have adopted a number of proposals and standards to further reduce the interference between devices competing to use the electronic spectrum. IEEE 802.19.1 is one example of the efforts put forth by the IEEE to allow for the coexistence of different wireless systems on the same radio frequency band. IEEE 802.19.1 provides for the coexistence of TV Band Device networks and dissimilar TV Band Devices. Such devices are able to coexist based on different transmission schedules managed by a hierarchy of coexistence managers and coexistence enablers. Coexistence managers exchange information with other coexistence managers and provide coexistence decision making Coexistence enablers operate as the interface between the coexistence managers and the TV Band Device networks and TV Band Devices. IEEE 802.11 of is another example of an IEEE effort that allows for wireless local area network (WLAN) to operate in a portion of the electromagnetic spectrum used for TV white space devices such as between 54 and 790 MHz.

Regulatory changes may open particular bands currently used by radar systems for secondary use by communication systems, such as WiFi and Long Term Evolution (LTE) communications. As one potential regulatory change, the S band (2 to 4 Gigahertz (GHz)), which is used, among others, by radar systems for air traffic control, long-range weather, and surface ship detection, may be opened for secondary use by communication systems.

As regulations change and as different wireless technologies emerge, new combinations of wireless technology may be competing for the same radio frequency band. As such, existing mechanisms designed to allow for the coexistence of certain wireless technologies may prove inefficient or insufficient at reducing interference between the new combination of wireless technology so that they can coexist.

### SUMMARY

This Summary is provided to introduce a selection of concepts in a simplified form that are further described below in the Detailed Description. This Summary is not intended to identify key or essential features of the invention.

Embodiments include an example system architecture that enables the coexistence of wireless communications and radar. Some embodiments include the coexistence of such systems on the S band (2 to 4 GHz). For example, the system architecture described herein may enable the coexistence of dual band radar, air traffic control radar, Wi-Fi and LTE communications on the S band.

Embodiments include, without limitation, a computing device that, for example, may be in communication with an access node for communicating with secondary devices via a first wireless technology that is to coexist with a second wireless technology on a radio frequency band. The first wireless technology may be a wireless communication technology such as WiFi or LTE. The second wireless technology may be radar. The computing device may transmit a channel usage request to another device, such as a shared spectrum access database. The computing device may receive a response to the channel usage request that indicates whether usage of the second wireless technology on the radio frequency band has changed and indicates a time the computing device is to transmit another channel usage request. Another computing device, such as a shared spectrum access database that is in communication with an interface device of the second wireless technology, may receive the channel usage request from the computing device and may transmit the response to the channel usage request.

Additional embodiments and details are disclosed herein.

### BRIEF DESCRIPTION OF THE DRAWINGS

Some embodiments are illustrated by way of example, and not by way of limitation, in the FIGS. of the accompanying drawings and in which like reference numerals refer to similar elements.

FIG. 1 depicts an illustrative example of a system architecture for the coexistence of radar and communication systems in accordance with various embodiments.

FIG. 2 illustrates an example method for maintaining spectrum usage information and for determining whether spectrum usage has changed in accordance with various embodiments.

FIG. 3 illustrates an example method for receiving an indication of whether spectrum usage has changed and controlling a communications system to allow or deny communication services in accordance with various embodiments.

FIG. 4 illustrates an example structure for a channel usage request in accordance with various embodiments.

FIG. 5 illustrates an example structure for an acknowledgement in accordance with various embodiments.

FIG. 6 illustrates an example structure for channel usage information in accordance with various embodiments.

FIG. 7 illustrates an example process flow diagram for radar systems coexisting with a communication system in accordance with various embodiments.

FIG. 8 shows an illustrative computing device in accordance with various embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Some wireless technologies, such as radar technologies, have a number of properties and are subject to a number of regulations that make coexistence with other wireless systems a challenge. Radar technologies use radio waves to detect the range, altitude, direction, or speed of objects. Radar is commonly used today in air traffic control and in monitoring meteorological effects, such as precipitation. The performance of radar, however, is sensitive to interference. To lessen the risk of other systems interfering with radar, the FCC has imposed regulations that deny the use of a channel if a radar system is detected as using the channel.

As a further challenge for coexisting with radar, a radar system may change its operating frequency quite frequently (sometimes referred to as frequency agility). For example, radar systems may operate at any one time at one or more frequencies within one or more narrow operating bands (e.g., a 2 MHz band or a 5 MHz band). The radar system may be configured to change an operating frequency (e.g., every 100 milliseconds or so) to account for undesired effects from potential sources of interference (e.g., environmental factors, jamming sources, and the like). To reduce the chance that secondary devices will interfere with the radar system's operations, it may be important to maintain accurate and up-to-date information about the spectrum usage (also similarly referred to as spectrum occupancy).

Many embodiments will be described in terms of radar systems coexisting with communication systems. The methods and system architectures described herein may be applied to other combinations of wireless technologies. For example, instead of radar systems, the methods and system architectures described herein may be applied so other frequency agile wireless technologies, such as Bluetooth or Zigbee, may coexist with communications systems at reduced levels of interference.

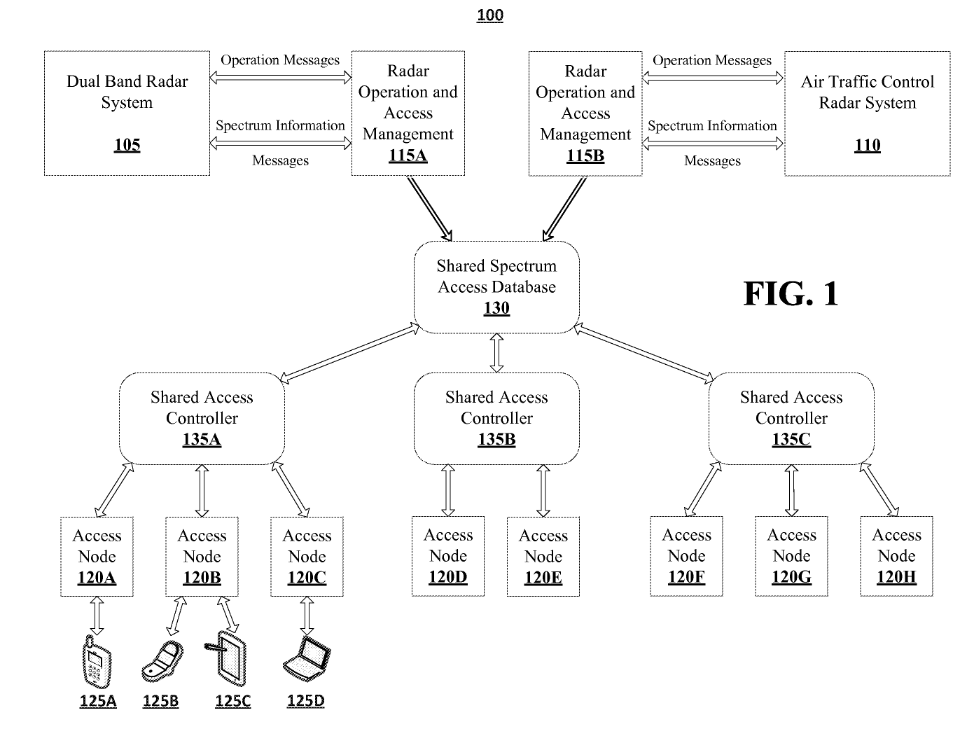

FIG. 1 depicts an illustrative example of a system architecture for the coexistence of radar and communication systems. The example depicts a networked environment 100 where two radar systems may coexist with a number of access nodes of a communication system. Dual band radar system 105 and air traffic control radar system 110 are just two examples of the types of radar systems that could be included in a system that shares spectrum with a communication system.

Access nodes 120A-120H of the communication system may be located at various geographic locations. Each access node may provide one or more communication services to secondary devices, such as computing devices 125A-125D (e.g., smartphone 125A, cell phone 125B, tablet computer 125C, personal computer or laptop computer 125D). Although computing devices 125A-125D illustrate particular types of devices, any other type of mobile or computing device that is capable of communicating with an access node could be used.

In some embodiments, access nodes 120A-120H may provide Wi-Fi services or wireless local access network (WLAN) services to computing devices based on an IEEE 802.11 specification. Access nodes 120A-120H may provide services for other types of wireless technologies, such as LTE, Worldwide Interoperability for Microwave Access (WiMAX), Evolved High-Speed Packet Access (HPSA+), or other type of 3^{rd} generation (3G) or 4^{th} generation (4G) wireless technology. The access nodes 120A-120H may, in some embodiments, be base stations for an LTE communications system or access points for a Wi-Fi or WLAN communications system. For example, access nodes 120A-120H may be femto base stations or femtocells. In some arrangements, a femto base station may be configured to wirelessly communicate with one or more secondary devices (e.g., devices 125A-125D) and provide the one or more secondary devices with access to a communication service via a public-switched telephone network.

As a condition of radar systems coexisting with communication systems, information describing how each radar system is using the spectrum may be maintained by one or more devices throughout the networked environment 100. Shared spectrum access database 130 is illustrated as being in communication with the radar systems to receive and store records of each radar system's spectrum usage. A radar system's spectrum usage, however, may be considered a trade secret or confidential. Thus, in some embodiments, shared spectrum access database 130 may be a global database that serves as the only point of contact in the network between radar systems and communication systems.

Shared spectrum access database 130 may communicate with a radar system via an interface device such as, for example, radar operation and access management device 115A for the dual band radar system 105A, and radar operation and access management device 115B for the air traffic control radar system 110. The interface device may communicate with the radar system to exchange messages related to the radar system's operation (e.g., operation messages) and spectrum usage (e.g., spectrum information messages) and maintain records of the radar system's spectrum usage and operation. Such records may include a record of current operating frequencies (e.g., a record of one or more operating frequencies in the S Band) and/or a record of current narrow operating bands (e.g., a record of one or more 2 MHz-wide or 5 MHz-wide operating bands in the S Band). The interface device may from time to time transmit information describing the radar system's spectrum usage (e.g., radar usage information) to the shared spectrum access database 130. For example, the interface may transmit radar usage information periodically or on an as-needed basis (e.g., whenever the radar system changes an operating frequency). The interface device may send the radar usage information on a frequent basis due in part to some radar systems having the ability to switch operating frequencies frequently (e.g., every 100 milliseconds).

In addition to the shared spectrum access database 130, networked environment 100 of FIG. 1 includes a number of shared access controllers 135A-135C. Each shared access controller 135A-135C may include a database for storing information received from a shared spectrum access database and/or one or more access nodes. The shared spectrum access database 130 and the shared access controllers 135A-135C may together form a hierarchy of devices and/or databases to facilitate the coexistence of radar and communication systems. Indeed, as illustrated in FIG. 1, each of the shared access controllers 135A-135C are in communication with a subset of access nodes 120A-120H and each of the shared access controllers 135A-135C is in communication with the shared spectrum access database. In some embodiments, a shared access controller may communicate with a shared spectrum access database via a wired (e.g., optical backhaul or Internet) or wireless (e.g., Wi-Fi or LTE) connection.

An access node may report its usage of the electromagnetic spectrum to a shared access controller. For example, access node 120A may transmit, to shared access controller 135A, one or more messages that includes information describing one or more channels that access node 120A is using to communicate with secondary device 125A. The messages, in some embodiments, may be transmitted via an optical backhaul or via the Internet.

In some embodiments, shared access controllers 135A-135C may be authorized to receive information describing the radar system's spectrum usage. Accordingly, such information describing the radar system's spectrum usage may be transmitted to authorized controllers from the shared spectrum access database. Based on the radar system's spectrum usage, a shared access controller may control an access node to allow or deny communication services on one or more channels of the radio frequency band. A shared access controller may be configured to select which channels are available for use by the access nodes when providing communication services to the secondary devices (e.g., a preferred channel list for use by the access nodes in communication with the shared access controller).

In some embodiments, a shared spectrum access database 130 may place one or more conditions that a device is to satisfy before a radar system's spectrum usage will be shared with the device. For example, a shared access controller may be required to authenticate itself or receive a license before the shared spectrum access database 130 will transmit usage information to the shared access controller. The shared spectrum access database 130 may further, for example, specify a time at which a controller is to request channel usage information or specify a duration between such requests.

The shared spectrum access database 130 may store or otherwise have access to geographic indicators associated with the shared access controllers and radar systems. For example the geographic indicators may identify where each of the shared access controllers and radar systems are located, may identify the geographic areas served by each of the shared access controllers, or may identify the geographic areas affected by each of the radar systems. In some embodiments, the geographic indicators may be a listing of latitude and longitude positions and each entry on the list may be associated with one of the shared access controllers or one of the radar systems.

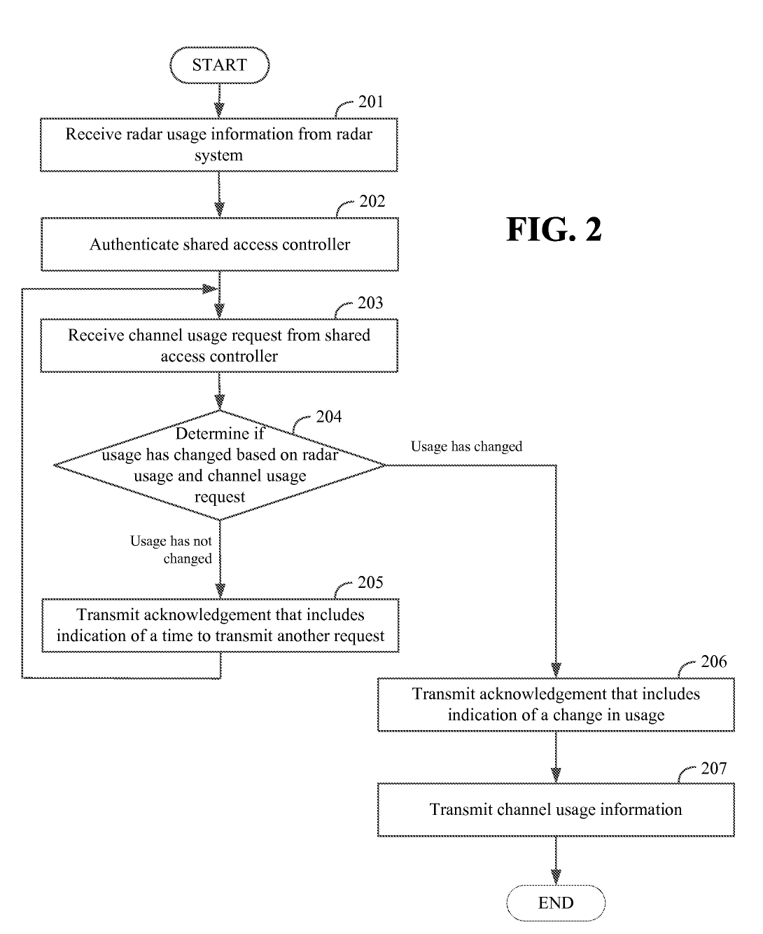

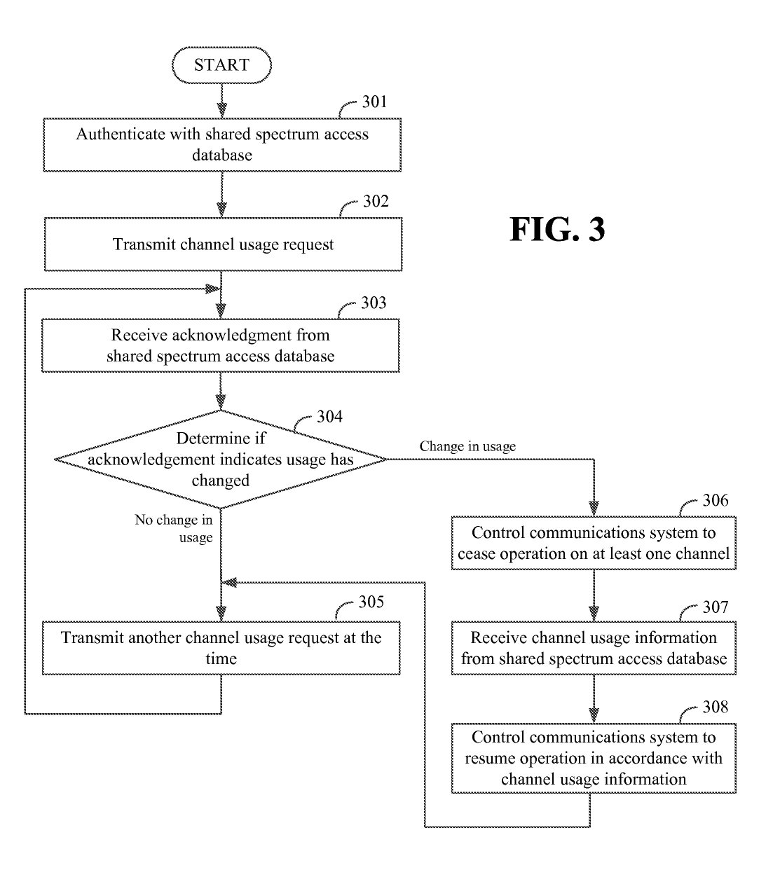

FIGS. 2 and 3 illustrate example methods for enabling the coexistence of radar and communication systems.

In particular, FIG. 2 illustrates an example method for maintaining spectrum usage information and for determining whether spectrum usage has changed. The example method of FIG. 2 may be performed by the shared spectrum access database 130 of FIG. 1.

At step 201, a shared spectrum access database may receive radar usage information from one or more radar systems. The radar usage information may be received from the radar system via an interface device (e.g., radar operation and access management device 115A or 115B of FIG. 1). Once received, the shared spectrum access database may store the radar usage information or use it to update a stored record of the radar system's usage. In some instances, the radar usage information may take the form of, for example, a listing of the radar system's operating frequencies and a number of properties related to how the radar is using the spectrum (e.g., transmission power, operating bandwidth, scanning schedule, and the like). Features related to step 201 (e.g., the receiving and storing of the radar usage information) may be performed separately from the other steps of FIG. 2. For example, step 201 may be performed by the shared spectrum access database in its own thread, so that the shared spectrum access database is able to promptly receive and process the radar usage information.

At step 202, the shared spectrum access database may authenticate a shared access controller. The authentication of a shared access controller may begin responsive to receiving a request for authentication from the shared access controller. In some embodiments, authenticating the shared access controller may include comparing an address, such as a media access control (MAC) address of the shared access controller, against an authenticated device list stored by the shared spectrum access database. If the MAC address is not found on the authenticated device list, the shared spectrum access database may transmit an authentication failure response to the shared access controller. If the MAC address is found on the authenticated device list, the shared spectrum access database may transmit an authentication success response to the shared access controller. In some embodiments, the MAC address may be encrypted by a shared key.

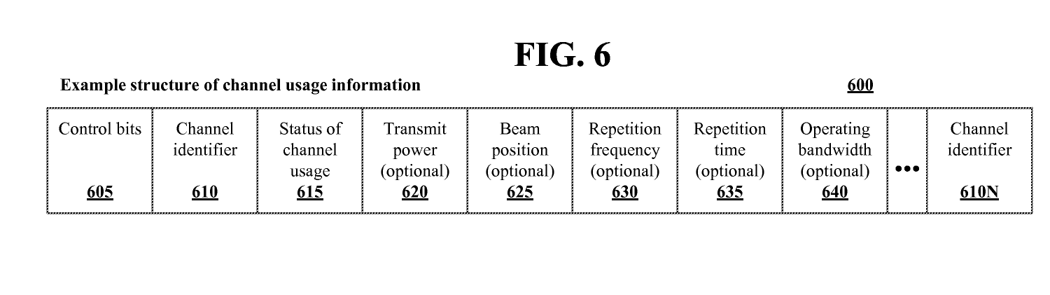

In some embodiments, if authentication was successful, the shared spectrum access database may accompany the authentication response with information for initializing the shared access controller. The initialization information may include channel usage information (e.g., the channel usage information frame of FIG. 6) that describes, for example, the status of usage for each of the available channels in a radio frequency band that the communications system is to share with the radar systems. The initialization information may include an indication of a time to send a channel usage request to the shared spectrum access database such as, for example, by including a data field defining a periodic interval between transmissions to the shared spectrum access database or a data field defining a duration the shared access controller is to wait between sending the authentication request and sending the first channel usage request.

Features related to step 202 (e.g., the authenticating of the shared access controller and the transmitting of initialization information) may be performed separately from the other steps of FIG. 2. For example, step 202 may be performed by the shared spectrum access database in its own thread, so that the shared spectrum access database is able to promptly receive and process authentication requests from shared access controllers.

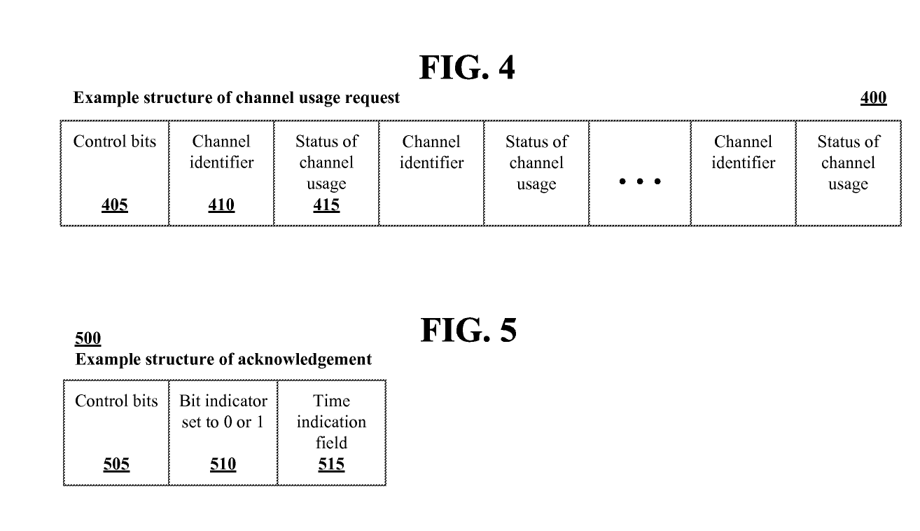

At step 203, the shared spectrum access database may receive a channel usage request from a shared access controller (which was previously authenticated at step 202). In some embodiments, the channel usage request may include information describing how the access nodes in communication with the shared access controller are using the channels of a radio frequency band. FIG. 4 illustrates an example structure for a channel usage request.

As shown in FIG. 4, the channel usage request 400 may include a field for control bits 405 that allow for identification of the channel usage request. The channel usage request 400 may include one or more channel identifiers and a corresponding status of usage for each channel. As illustrated, channel usage request 400 may include a channel identifier 410 and a corresponding status of channel usage 415. Following channel identifier 410 and status of channel usage 415 may be a number of channel identifiers and statuses of channel usage for the remaining channels in the radio frequency band that is to be shared between the radar systems and the communication systems.

The status of channel usage 415 may indicate whether the channel is being used by an access node in communication with the shared access controller. For example, the status of channel usage 415 may be a single bit field. The bit field being set to 0 may indicate the channel is not being used by at least one of the access nodes and the bit field being set to 1 may indicate the channel is being used by at least one of the access nodes.

In some embodiments, the channel usage request 400 may include a preferred channel list. For example, the channel usage request may include identifiers for channels available and preferred for use by the access nodes, and may include corresponding statuses of channel usage to indicate whether at least one access node is using the channel or not. The identifiers may be in the preferred order used by the access nodes when they communicate with secondary devices. For example, if the preferred channel list was sent from shared access controller 135A of FIG. 1, the list may include the channels available for use by access nodes 120A-120C when communicating with secondary devices, such as devices 120A-120D. Accordingly, channel identifier 410 may identify the channel that is preferably used by the access nodes 120A-120C of FIG. 1 when communicating with secondary devices (e.g., the channel identified by channel identifier 410 has the highest priority). In some embodiments, the preferred channel list may include only a subset of the channels in a radio frequency band. If a channel of the radio frequency band is not in the preferred channel list, the channel may not available for use and may not be currently used by the access nodes.

Referring again to FIG. 2, at step 204, the shared spectrum access database may determine if spectrum usage has changed based on the radar usage (e.g., the radar usage information received at step 201) and the channel usage request (e.g., the channel usage request received at step 203). The shared spectrum access database may determine that spectrum usage has changed based on whether any channel being used by an access node is also being used by radar.

For example, the shared spectrum access database may identify which radar systems may be potentially interfering with the operations of access nodes in communication with the shared access controller that transmitted the channel usage request. To accomplish this, the shared spectrum access database may identify which shared access controller transmitted the channel usage request and may determine a geographic area associated with the shared access controller (e.g., where the controller is located or the area that the controller serves). The geographic area may be determined based on, for example, the geographic indicators stored by or accessible to the shared spectrum access database. The geographic area associated with the shared access controller may be compared to the geographic indicators associated with one or more radar systems to determine if there is a risk of potential interference. For example, the geographic areas associated with the shared access controller and the geographic areas associated with the radar systems may each comprise a latitude and longitude coordinate and a radius.

If the shared spectrum access database identifies at least one potentially-interfering radar system, the shared spectrum access database may determine whether an access node in communication with the shared access controller is using a channel that interferes with an operating frequency or narrow operating band of a potentially-interfering radar system. To accomplish this, the shared spectrum access database may analyze the channel usage request to determine which channels are being used by at least one access node in communication with the shared access controller, such as by identifying which channels of the channel usage request have a status of channel usage that is set to 1. For each channel being used by at least one access node, the shared spectrum access database may determine whether one of the potentially-interfering radar systems is using that channel. If a potentially-interfering radar system is using the channel, the shared spectrum access database may determine that usage has changed and, accordingly, proceed to step 206. As one specific example, the channel usage request may identify channel 12 as being used by at least one access node. If channel 12 is being used by any of the radar systems, the method may proceed to step 206.

In some embodiments, to determine whether a potentially-interfering radar system is using a channel, the channel being used by the access node may be converted to a frequency range. The frequency range may be compared to the operating frequency of the potentially-interfering radar system to determine whether the operating frequency is within the frequency range. A narrow operating band of the potentially-interfering radar system could also be compared to the frequency range to determine whether the narrow operating band at least partially overlaps with the frequency range. If the frequency range or the narrow operating band of the potentially-interfering radar system is within or at least partially overlapping with the frequency range, it may be determined that the potentially-interfering radar system is using the channel. In other embodiments, the operating frequency or the narrow operating band of a potentially-interfering radar system may be mapped to identify a channel that includes the operating frequency/narrow operating band. If the channel that includes the operating frequency/narrow operating band matches or otherwise overlaps with the channel being used by the access node, it may be determined that the potentially-interfering radar system is using the channel.

If the access nodes are not using any channel (e.g., the status of each channel listed in the channel usage request is set to 0), the shared spectrum access database may determine that usage has not changed and may proceed to step 205. As one specific example, if the channel usage request identifies channels 1 through 4 and indicates that channels 1 through 4 are not being used, the method may proceed to step 205. If each channel being used by at least one access node is not also being used by any of the radar systems (e.g., each radar system is operating on different channels/operating frequencies), the shared spectrum access database may determine that usage has not changed and may proceed to step 205. As one specific example, the channel usage request may identify channels 10 through 14 and may indicate channel 13 as being used by at least one access node. If channel 13 is not being used by any of the radar systems, the method may proceed to step 205.

At step 205, the shared spectrum access database may transmit an acknowledgement to the shared access controller as a response to the channel usage request (which was received at step 203). FIG. 5 illustrates an example structure for an acknowledgement.

As shown in FIG. 5, the acknowledgement 500 may include a field for control bits 505 that allow for identification of the acknowledgement. The acknowledgement may indicate whether the usage has changed or not. For example, the acknowledgement 500 may include a bit indicator that is set to 0 or 1 depending on the determination performed at step 204. The acknowledgement 500 may include a time indication field 515 that indicates when the shared access controller is to transmit another channel usage request. In some embodiments, the time indication field may define a duration or interval between channel usage requests, and may be a number of tens of milliseconds.

Referring again to step 205 of FIG. 2, the shared spectrum access database may transmit, to the shared access controller that sent the request received at step 203, an acknowledgement that includes a bit indicator set to 0 (to indicate no change in usage), and an indication of time field set, for example, to 10, which indicates that the shared access controller is to send another channel usage request 100 milliseconds after the previous channel usage request.

At step 206 of FIG. 2, the shared spectrum access database may transmit, to the shared access controller that sent the request received at step 203, an acknowledgement that includes a bit indicator set to 1 (to indicate usage has changed), and an indication of time field set, for example, to 20, which indicates that the shared access controller is to send another channel usage request 200 milliseconds after the previous channel usage request.

The shared spectrum access database may determine the duration or interval for the indication of time field in various ways. In some embodiments, the duration/interval may be preset by a network operator. In other embodiments, the duration/interval may be determined based on information received from the radar system. For example, the shared spectrum access database may store or have access to information about a radar system's scanning schedule. A radar system may change the scanning schedule, for example, based on whether an object has been detected. If the scanning schedule of one of the potentially-interfering radar systems has changed within a time window, the duration/interval may be adjusted to a different value.

At step 207, the shared spectrum access database may transmit, to the shared access controller that sent the request received at step 203, channel usage information, which may inform the shared access controller of the change in usage. FIG. 6 illustrates an example structure for channel usage information.

As shown in FIG. 6, the channel usage information 600 may include a field for control bits 605 that allow for identification of the channel usage information. The channel usage information may include a listing of channels that are available in a frequency band being shared (e.g., channel identifier 610 through channel identifier 610N) and a corresponding status of each channel's usage (e.g., status of channel usage 615 indicates the status of the channel identified by channel identifier 610 via a bit field being set to 0 or 1). Status of channel usage 615 may indicate whether the channel identified by channel identifier 610 is being used by a radar system (e.g., set to 1 if being used or set to 0 if not being used). In some embodiments, the listing of channels may include channels that where included in a channel usage request that was received from a shared access controller. For example, the listing of channels of the channel usage information transmitted at step 207 may include the same channels as the channel usage request received at step 203.

In some embodiments, the channel usage information 600 may include a number of optional fields for each listed channel. The optional fields may inform the shared access controller with one or more properties related to the radar system's usage of the channel. For example, channel usage information 600 may include transmit power 620 to indicate the power at which a radar system is using the channel, a beam position 625 at which the radar system is transmitting, a repetition frequency 630 at which the radar system is transmitting, a repetition time 635 at which the radar system is transmitting, and an operating bandwidth 640 that the radar system is occupying. Other types of optional fields that describe one or more properties related to the radar system's usage of the channel are possible and the types of optional fields may depend on the information received from the radar system (e.g., via the interface device described in FIG. 1).

In some embodiments, the optional fields (or a subset of the optional fields) may be included in the channel usage information only for channels that are indicated by the channel usage information as being used (e.g., have a status of channel usage set to 1). The optional fields (or a subset of the fields) may be included based on whether the shared access controller is authorized to access such information about the radar information. For example, the shared spectrum access database may provide for multiple levels of authentication/licensing. If the shared access controller has the appropriate license or passes a stricter authentication process, the optional fields may be included in the channel usage information. This may result in some instances where the shared spectrum access database sends the optional fields to one shared access controller (e.g., controller 135A of FIG. 1, which has a license to receive the optional fields) but not to another shared access controller (e.g., controller 135B of FIG. 1, which has license to receive some radar information but not the optional fields).

FIG. 3 illustrates an example method for receiving an indication of whether spectrum usage has changed and controlling a communications system to allow or deny communication services. The example method of FIG. 3 may be performed by any of the shared access controllers 135A-135C of FIG. 1.

At step 301, a shared access controller may authenticate with a shared spectrum access database (e.g., shared spectrum access database 130 of FIG. 1). For example, the shared access controller may, as part of a process of connecting to a network, send an authentication request to the shared spectrum access database. The authentication request may include the MAC address of the shared access controller. The MAC address may be in an encrypted form, which resulted by encrypted the clear MAC address using a shared key. If authentication with the shared spectrum access database was successful, the shared access controller may receive an authentication response that indicates authentication is successful. Additionally, if successful, the shared access controller may receive initialization information that allows the shared access controller to begin controlling an access node's access to the radio frequency band. Such initialization information, as described in connection with step 202 of FIG. 2, may include, for example, channel usage information and an indication of a time to send a channel usage request to the shared spectrum access database.

After authentication, the shared access controller may determine an initial preferred channel list that access nodes are to use when providing communication services to secondary devices. Such a preferred channel list may be transmitted to each access node in communication with the shared access controller.

At step 302, the shared access controller may transmit a channel usage request to the shared spectrum access database. The time at which the channel usage request is transmitted may depend on the indication of time received at step 201. The channel usage request may be similar to the data structure depicted in FIG. 4. In some embodiments, the channel usage request may be the preferred channel list currently being used by the access nodes in communication with the shared access controller.

At step 303, the shared access controller may receive an acknowledgement from the shared spectrum access database. The acknowledgement may be similar to the data structure depicted in FIG. 5.

At step 304, the shared access controller may determine if the acknowledgment indicates a change in usage. As discussed above in connection with FIG. 5, the acknowledgement may indicate a change in usage by setting bit indicator 510 to 0 or 1. Accordingly, if the bit indicator of the acknowledgement received at step 302 is set to 0, the shared access controller may determine that usage has not changed and may proceed to step 305. If the bit indicator of the acknowledgement received at step 302 is set to 1, shared access controller may determine that usage has changed and may proceed to step 306.

At step 305, the shared access controller may transmit another channel usage request at the time indicated in the acknowledgement. For example, as discussed above in connection with FIG. 5, the acknowledgement may include a time indication field 515. Based on the value of the time indication field of the acknowledgement received at step 302, the shared access controller may determine that it is to transmit another channel usage request 100 milliseconds after the previous request (e.g., the request transmitted at step 302). Accordingly, the shared access controller may transmit another channel usage request when 100 milliseconds has elapsed from the transmission time of the previous request.

At step 306, the shared access controller may have determined that there has been a change in usage and, therefore, may control the communications system to cease operation on at least one channel of the radio frequency band. To control the communications system, the shared access controller may transmit a flag or other data to the access nodes in communication with the shared access controller, which causes each access node to deny usage to one or more channels of the radio frequency band. For example, in some embodiments, each of the access nodes may be controlled to cease operation on the channel it is currently occupying (but other channels may be used). In others, each of the access nodes may be controlled to cease operation on the entire frequency band until operations are resumed.

At step 307, the shared access controller may receive channel usage information from the shared access database. The channel usage information may be similar to the data structure illustrated in FIG. 6. Based on the channel usage information, the shared access controller may determine a new preferred channel list. For example, the new preferred channel list may include one or more channels that are not being used by the radar systems, which may be identified by analyzing the channel usage information. In addition to being based on a radar system's usage of the electromagnetic spectrum, the new preferred channel list may be determined based on other spectrum usage information. For example, the new preferred channel list may be determined based on throughput of the channels, latency of the channels, quality of service (QoS) provisioning information, and/or information reported to the shared access controller from the access node regarding the node's usage. In some instances, the most preferred channel of the new preferred channel list may be the channel that has the greatest throughput of the listed channels or the lowest latency of the list channels.

At step 308, the shared access controller may control the communications system to resume operation in accordance with the channel usage information. For example, the shared access controller may transmit a flag or other data to the access nodes in communication with the shared access controller, which causes each access node to resume usage on at least one channel of the radio frequency band. The shared access controller may also transmit the new preferred channel list to the access nodes so that each access node accesses the radio frequency band via the channels indicated in the new preferred channel list.

After step 308, the shared access controller may proceed to step 305 in order to transmit another channel usage request at the time indicated in the acknowledgement received at step 303.

As discussed above in connection with the example methods of FIGS. 2 and 3, various messages may be transmitted between a shared spectrum access database and a shared spectrum controller including, for example, a channel usage request, an acknowledgement, and channel usage information. Example data structures for the channel usage request, acknowledgement and channel usage information are depicted in FIGS. 4-6. A channel usage request, an acknowledgement and channel usage information may include additional information not depicted in the examples of FIGS. 4-6. For example, receiver and transmitter addresses may be included in a channel usage request, acknowledgement or channel usage information. Error checking fields (e.g., a cyclic redundancy check) may be included in a channel usage request, acknowledgement or channel usage information.

In some embodiments, the shared spectrum access database and shared spectrum controller may communicate with each other and the other devices at the data link layer (e.g., layer 2 of the open systems interconnection (OSI) model). Thus, in some embodiments, the channel usage request may be transmitted as a channel usage frame, an acknowledgement may be transmitted as an acknowledgement frame, and channel usage information may be transmitted as a channel usage information frame. In some embodiments, the frames may conform to a variant of a communications standard such as IEEE 802.22. In some such embodiments, the bit indicator of the acknowledgement frame (e.g., bit indicator 510) may replace one of the bits reserved by that standard for future use. Other methods of communication could be used by the shared spectrum access database and shared spectrum controller when communicating with each other including, for example, Wi-Fi (e.g., via data transmissions conforming to a variant of IEEE 802.11) and LTE communications (e.g., via data transmissions conforming to LTE developed by the 3^{rd} Generation Partnership Project (3GPP)).

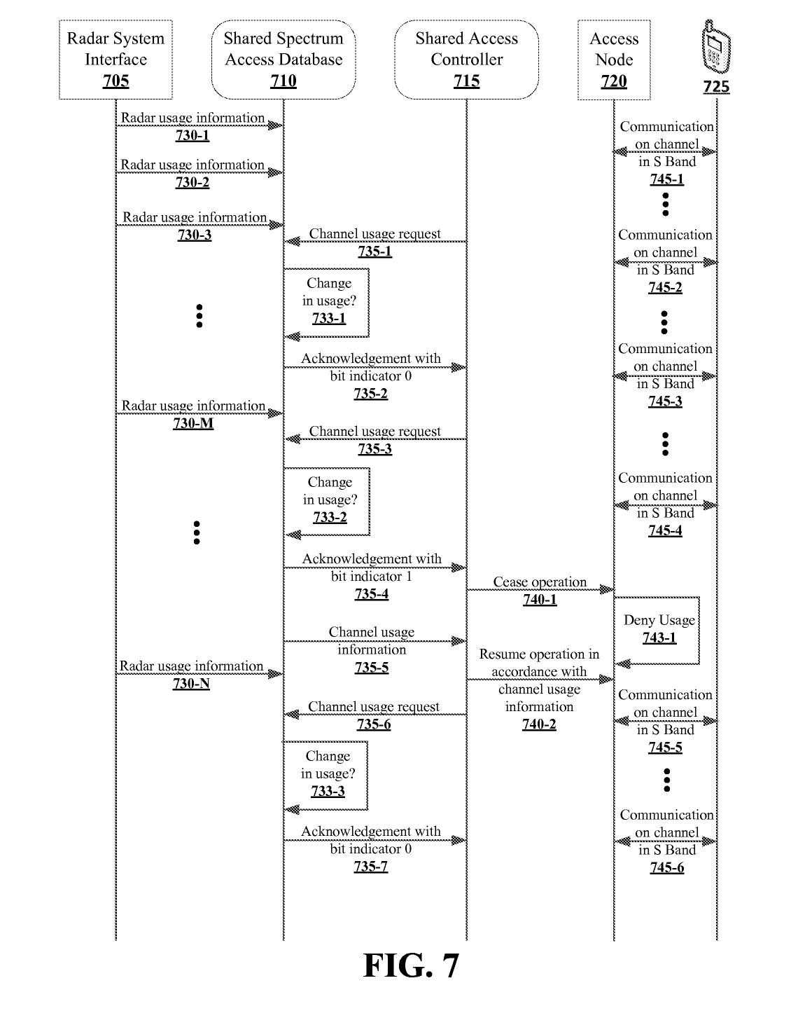

FIG. 7 illustrates an example process flow diagram for radar systems coexisting with a communication system. The example process flow illustrates an example of a radar system coexisting with a communications system that provides a wireless service (e.g., Wi-Fi, LTE) on the S Band. The example process flow further provides an example where the radar system interface 705 reports a change in the radar system's usage, which causes the access node 720 to deny usage to secondary device 725 for a period of time. The shared spectrum access database 710 depicted in FIG. 7 may execute a method similar to the example of FIG. 2 and the shared access controller 715 depicted in FIG. 7 may execute a method similar to the example of FIG. 3.

The example process flow of FIG. 7 may begin after the shared access controller 715 and the shared access database 710 have established communication with each other and after the shared access controller 715 has been authenticated with the shared spectrum access database 710. The example process flow may further begin after the access node 720 has initiated communication with the secondary device 725 on a channel of the S Band (e.g., as represented by communications at 745-1 through 745-4).

As depicted in FIG. 7, the radar system interface 705 may, from time to time, transmit radar usage information to the shared spectrum access database and such transmissions are represented at 730-1 through 730-3. Radar usage information may or may not include a change from a previous transmission of usage information from the radar system interface 705. Indeed, in the depicted example, radar usage does not change until some point after the acknowledgement is transmitted from the shared spectrum access database 710 at 735-2.

Shared access controller 715 may transmit a channel usage request to the shared spectrum access database 710 at 735-1. Upon receiving the channel usage request, the shared spectrum access database 710 may determine if there has been a change in usage based on the channel usage request and the radar usage information at 733-1. If a change has not occurred, the shared spectrum access database 710 may transmit an acknowledgement with a bit indicator set to 0 at 735-2. The acknowledgement also may indicate that channel usage requests should be transmitted every 100 milliseconds.

At 730-M, shared spectrum access database 710 may receive radar usage information from the radar system interface 705. This radar usage information may include a change to the radar's usage of the S Band (e.g., a change in the operating channel or frequency). In particular, the radar system may now be operating on a channel at which the base station 720 is communicating with secondary device 725.

At 735-3, shared spectrum access database 710 receives another channel usage request from the shared access controller 715. This channel usage request may have been transmitted 100 milliseconds after the transmission at 735-1. The shared spectrum access database 710 may proceed to determine whether there has been a change in usage. In this instance, the shared spectrum access database 710 may determine that there has been a change based on the channel usage request received at 735-3 and the radar usage information received at 730-M. Accordingly, the shared spectrum access database 710 may transmit an acknowledgement with a bit indicator set to 1 at 735-4.

Upon receiving the acknowledgement with a bit indicator set to 1, the shared access controller 715 may transmit data to cause the access node 720 to cease operation on at least the channel in the S Band at 740-1. In some embodiments, the access node 720 may be controlled to cease operation on the channel that it is using to communicate with secondary device 725 (e.g., the channel used for the communications at 745-1 through 745-4) Accordingly, access node 720 stops communicating on the at least one channel and denies usage of the at least one channel in the S Band to secondary device 725.

At 735-5, the shared spectrum access database 710 may transmit channel usage information to the shared access controller 715, which may include an updated listing of channels or frequencies being used by the radar system. At 740-2, the shared access controller may transmit data to control the access node 720 to resume operation in accordance with the channel usage information. In some embodiments, controlling to resume operation may include transmitting a new preferred channel list that lists channels within the S Band that the access node is to use when communicating with the secondary device 725. Accordingly, communication on the S Band between the access node 720 and the secondary device 725 resumes at 745-5 and continues at 745-6. The channel on which the communications at 745-5 and 745-6 occur may be different than the channel used during the communications at 745-1 through 745-4.

When it is time for the shared access controller 715 to transmit another request (e.g., per the time indicated in the acknowledgement at 735-4), the shared access controller makes another request at 735-6. Accordingly, the shared spectrum access database 710 may determine whether there is a change in usage at 733-3 and, because no change has occurred, the shared spectrum access database 710 may transmit an acknowledgement with a bit indicator set to 0 at 735-7.

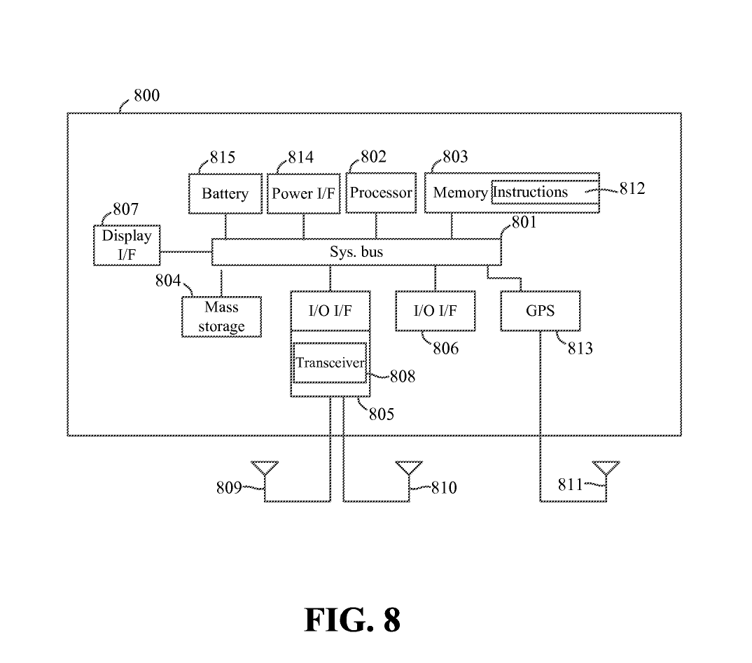

Various types of computers and apparatuses can be used to implement computing devices (such as devices 115A-115B, 130, 135A-135C, 120A-120H and 125A-125D) according to various embodiments or to implement the methods and processes described herein (such as those described with respect to FIGS. 2, 3 and 7). FIG. 8 shows an illustrative computing device 800 in accordance with example embodiments. Various devices described herein may include some or all of the illustrated components of device 800. Device 800 includes a system bus 801 which may operatively connect various combinations of one or more processors 802, one or more memories 803 (e.g., random access memory, read-only memory, etc.), mass storage device(s) 804, input-output (I/O) interfaces 805 and 806, display interface 807, and global positioning system (GPS) chip 813, power interface 814, and battery 815.

I/O interfaces 805 may include one or more transceivers 808, antennas 809 and 810, and other components for communication in the radio spectrum. Interface 806 and/or other interfaces (not shown) may similarly include a transceiver, one or more antennas, and other components for communication in the radio spectrum, and/or hardware and other components for communication over wired or other types of communication media. GPS chip 813 may include a receiver, an antenna 811 and hardware and/or software configured to calculate a position based on GPS satellite signals.

Memory 803 and mass storage device(s) 804 may store in a non-transient manner (permanently, cached, etc.), machine executable instructions 812 (e.g., software) executable by the processor(s) 802 for controlling operation of a device (such as devices 115A-115B, 130, 135A-135C, 120A-120H and 125A-125D) according to various embodiments or to implement the methods and processes described herein (such as those described with respect to FIGS. 2, 3 and 7).

Mass storage 804 may include a hard drive, flash memory or other type of non-volatile storage device. Processor(s) 802 may be, e.g., an ARM-based processor such as a Qualcomm Snapdragon or an x86-based processor such as an Intel Atom or Intel Core. Device 800 may also include a touch screen (not shown) and physical keyboard (also not shown). A mouse or keystation may alternately or additionally be employed. A physical keyboard might optionally be eliminated.

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments.

1. A method comprising:
transmitting, by a computing device in communication with an access node for communicating with secondary devices via a first wireless technology that is to coexist with a second wireless technology on a radio frequency band, a channel usage request; and
receiving, by the computing device, a response to the channel usage request that indicates whether usage of the second wireless technology on the radio frequency band has changed and indicates a time the computing device is to transmit another channel usage request.

2. The method of claim 1, wherein the first wireless technology is at least one of a Wi-Fi technology, a Long Term Evolution (LTE) technology, or a wireless local access network (WLAN) technology, and wherein the second wireless technology is radar.

3. The method of claim 1, further comprising:
determining that the response to the channel usage request indicates that usage has changed; and
responsive to determining that the response to the channel usage request indicates that usage has changed, transmitting data to the access node to control the access node to cease operation of the first wireless technology on at least one channel of the radio frequency band.

4. The method of claim 3, further comprising:
receiving, by the computing device, channel usage information that includes data identifying one or more channels and indicates a status of use for each of the one or more channels; and
based on the channel usage information, transmitting data to the access node to control the access node to resume operation of the first wireless technology on the at least one channel of the radio frequency band.

5. The method of claim 4, wherein the channel usage information includes data specifying two or more properties related to the second wireless technology's usage of the one or more channels.

6. The method of claim 5, wherein the second wireless technology is radar, and wherein the two or more properties are selected from a transmit power, a beam position, a repetition frequency, a repetition time, or an operating bandwidth.

7. The method of claim 1, further comprising:
transmitting, by the computing device, another channel usage request at the time indicated in the response to the channel usage request.

8. The method of claim 7, wherein the time the computing device is to transmit another channel usage request includes a duration between transmission of the channel usage request and transmission of the another channel usage request.

9. A method comprising:
receiving, by a first computing device in communication with an interface device of a first wireless technology that is to coexist with a second wireless technology on a radio frequency band, a channel usage request from a second computing device; and
transmitting, by the first computing device, a response to the channel usage request that indicates whether usage of the first wireless technology on the radio frequency band has changed and indicates a time the second computing device is to transmit another channel usage request.

10. The method of claim 9, wherein the first wireless technology is radar, and wherein the second wireless technology is at least one of a Wi-Fi technology, a Long Term Evolution (LTE) technology, or a wireless local access network (WLAN) technology.

11. The method of claim 9, wherein the channel usage request includes a preferred channel list for the second wireless technology, and wherein the method further comprises:
receiving, by the first computing device and from the interface device, first wireless technology usage information describing the first wireless technology's usage of the radio frequency band;
determining, based on the first wireless technology usage information and the preferred channel list, that usage of the first wireless technology has changed; and
responsive to determining that usage of the first wireless technology has changed, transmitting the response to the channel usage request and transmitting channel usage information that describes usage of the first wireless technology on the radio frequency band.

12. The method of claim 11, wherein the first wireless technology is radar, and wherein the channel usage information includes two or more of a transmit power, a beam position, a repetition frequency, a repetition time, or an operating bandwidth.

13. The method of claim 11, wherein the first wireless technology is radar, and the method further comprises:
determining a geographic area associated with the second computing device; and
identifying, based on the geographic area, a radar system that potentially interferes with the second computing device;
wherein determining that usage of the first wireless technology has changed includes determining that an access node in communication with the second computing device is using a channel that interferes with an operating frequency or narrow operating band of the radar system.

14. An apparatus comprising:
one or more processors; and
memory storing executable instructions that, when executed by the one or more processors, cause the apparatus to at least:
establish communication with an access node for communicating with secondary devices via a first wireless technology that is to coexist with a second wireless technology on a radio frequency band;
transmit a channel usage request; and
receive a response to the channel usage request that indicates whether usage of the second wireless technology on the radio frequency band has changed and indicates a time the apparatus is to transmit another channel usage request.

15. The apparatus of claim 14, wherein the first wireless technology is at least one of a Wi-Fi technology, a Long Term Evolution (LTE) technology, or a wireless local access network (WLAN) technology, and wherein the second wireless technology is radar.

16. The apparatus of claim 14, wherein the executable instructions, when executed by the one or more processors, cause the apparatus to:
determine that the response to the channel usage request indicates that usage has changed; and
responsive to determining that the response to the channel usage request indicates that usage has changed, transmit data to the access node to control the access node to cease operation of the first wireless technology on at least one channel of the radio frequency band.

17. The apparatus of claim 16, wherein the executable instructions, when executed by the one or more processors, cause the apparatus to:
receive channel usage information that includes data identifying one or more channels and indicates a status of use for each of the one or more channels; and
based on the channel usage information, transmit data to the access node to control the access node to resume operation of the first wireless technology on the at least one channel of the radio frequency band.

18. The apparatus of claim 17, wherein the channel usage information includes data specifying two or more properties related to the second wireless technology's usage of the one or more channels.

19. The apparatus of claim 18, wherein the second wireless technology is radar, and wherein the two or more properties are selected from a transmit power, a beam position, a repetition frequency, a repetition time, or an operating bandwidth.

20. The apparatus of claim 14, wherein the executable instructions, when executed by the one or more processors, cause the apparatus to:
transmit another channel usage request at the time indicated in the response to the channel usage request.
